(19) United States
(12) Patent Application Publication
(10) Pub. No.: US 2009/0040944 A1
(43) Pub. Date: Feb. 12, 2009

(54) Method and Bypass Device of Network-Based IP Allocation

(75) Inventors: Yang Yu, Beijing (CN); Hui Ning, Beijing (CN); Ruining Chen, Beijing (CN); Ran Chen, Beijing (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BEIJING ACK NETWORKS, INC., Beijing (CN)

(21) Appl. No.: 12/022,284

(22) Filed: Jan. 30, 2008

(30) Foreign Application Priority Data
Aug. 9, 2007 (CN) 200710120103.1

(51) Int. Cl. H04L 12/28

(52) U.S. Cl. 370/254

(57) ABSTRACT

The present invention provides a method and bypass device of IP allocation based on the network, the method comprising: establishing a mapping relation between the parameters of a visitor and an IP address; filing a request for visiting the network using the parameters of the visitor; performing authentication of AAA according to parameters of the visitor; finding the IP address corresponding to the successful parameters of the visitor from the mapping relation between the parameters of the visitor and the IP address and allocating the found IP address via DHCP to the network terminal being used by the visitor, to achieve the allocation of IP address based on the parameters of the visitor. The problem of the determination of the true identity of the visitor is solved and the safety of the network and the reasonable allocation of the network sources are improved. Other on-line or off-line devices are set using the IP address section correspond to the parameters of the visitor and thus, making these devices to realize the existing functions of the network devices according to the parameters of the visitor.

### CROSS-REFERENCES TO RELATED APPLICATIONS

This patent claims priority to Chinese patent application number 200710120103.1, filed Aug. 9, 2007, the disclosure of which is incorporated by reference in its entirety.

### FIELD OF THE INVENTION

The present invention relates to the technical field of network, in particular, to the administration and allocation of IP address in a network, specifically, to a method and bypass device of network-based IP allocation.

### BACKGROUND OF THE INVENTION

Existing networks are IP-based networks, as shown in FIGS. 1 and 3, wherein the terminals are connected to the server ACK via the network. Following steps (as shown in FIG. 4) are performed for a visitor in visiting a network: 1) filing a request at the terminal of the network for visiting the network; 2) the server ACK requiring authentication; 3) the DHCP server allocating IP address to the terminal of the network after the AAA authentication is passed; 4) logging in to visit the network on the basis of the allocated IP address.

As shown in FIG. 2, the network devices in the network (such as router, exchanger, firewall, VPN and IDS, etc.) perform management and communication based on the IP address. For example, the way of an existing firewall is: checking the IP header, and a decision is made on the accept/drop according to the IP source address. The log of a firewall is also recorded based on the IP, and the link and the time of visiting corresponding to every IP may be found in the log.

In prior art, the control of access is also achieved based on the IP, for example, different IP addresses are allocated to every user, and then relevant strategies are deployed at the firewall in light of different IP addresses. The allocation of different IP addresses to different visitors is shown in Table 1 as follows:

TABLE 1

| Name | Computer | IP |
|---|---|---|
| A | PC201 | 192.168.1.8 |
| B | PC203 | 192.168.1.9 |
| C | PC205 | 192.168.1.17 |

The right of allocation of each IP address is shown in Table 2 as follows:

TABLE 2

| | Access to the | |
|---|---|---|
| IP | internal server | Access to Internet |
| 192.168.1.8 | Yes | Yes |
| 192.168.1.9 | Yes | No |
| 192.168.1.17 | No | No |

Through the deployment on the firewall, the objective set in tables 1 and 2 may be achieved, the right set for A, B and C may be managed and the aim of standardized administration of the network may be realized.

The network administration and communication, however, have the deficiencies as follows:

As the IP address is always dynamically allocated to the location of the network terminal, the true identity of the visitor may not be determined, which would bring troubles to the safety of the network and the reasonable allocation of the network sources.

### SUMMARY OF THE INVENTION

The object of the present invention is to provide a method of IP allocation and bypass device based on the network, for resolving the problem of the determination of the true identity of the visitor and improving the safety of the network and the reasonable allocation of the network sources. The technical solution of the present invention is:

A method of IP allocation based on the network, comprising: establishing a mapping relation between the parameters of a visitor and an IP address; filing a request for visiting network using the parameters of the visitor; performing authentication of AAA according to parameters of the visitor; finding the IP address corresponding to the successful parameters of the visitor from the mapping relation between the parameters of the visitor and the IP address and allocating the found IP address via DHCP to the network terminal being used by the visitor, to achieve the allocation of IP address based on the parameters of the visitor.

A bypass device of IP allocation based on the network, comprising: a mapping relation memory unit for memorizing the mapping relation between the parameters of a visitor and an IP address; a receiving unit of request for visiting the network, for receiving the request for visiting the network filed employing the parameters of the visitor; an AAA authentication unit for performing authentication of AAA according to the received parameters of the visitor; an IP address allocation unit for finding the IP address corresponding to the successful parameters of the visitor from the mapping relation between the parameters of the visitor and the IP address and allocating the found IP address via DHCP to the network terminal being used by the visitor.

The advantages of the present invention are that the IP address allocation based on the parameters of the visitor is achieved, the problem of the determination of the true identity of the visitor is resolved and the safety of the network and the reasonable allocation of the network sources are improved.

### BRIEF DESCRIPTION OF THE DRAWINGS

FIG. 1 is a schematic view of the relation of connection between a network terminal and a server of the prior art;

FIG. 2 is a schematic view of the relation of connection based on IP between a network terminal and a network device of the prior art;

FIG. 3 is a schematic view of the relation of connection between a network terminal and an AAA server and a DHCP server of the prior art;

FIG. 4 is a flowchart of logging in visiting the network of the prior art;

FIG. 5 is a schematic view of the relation of connection between a bypass device and the network of the present invention;

FIG. 6 is a block diagram of the bypass device of the present invention;

FIGS. 7-12 are diagrams of mapping relations between the parameters of a visitor and an IP address of the present invention;

FIG. 13 a schematic diagram of the IP address allocation according to an embodiment of the present invention;

FIG. 14 is flowchart of an embodiment of the method according to the present invention;

FIG. 15 and 16 are schematic diagrams of the relation of connection between the device and the firewall of the present invention; and

FIG. 17 is a block diagram of the embodiment of the device of the present invention.

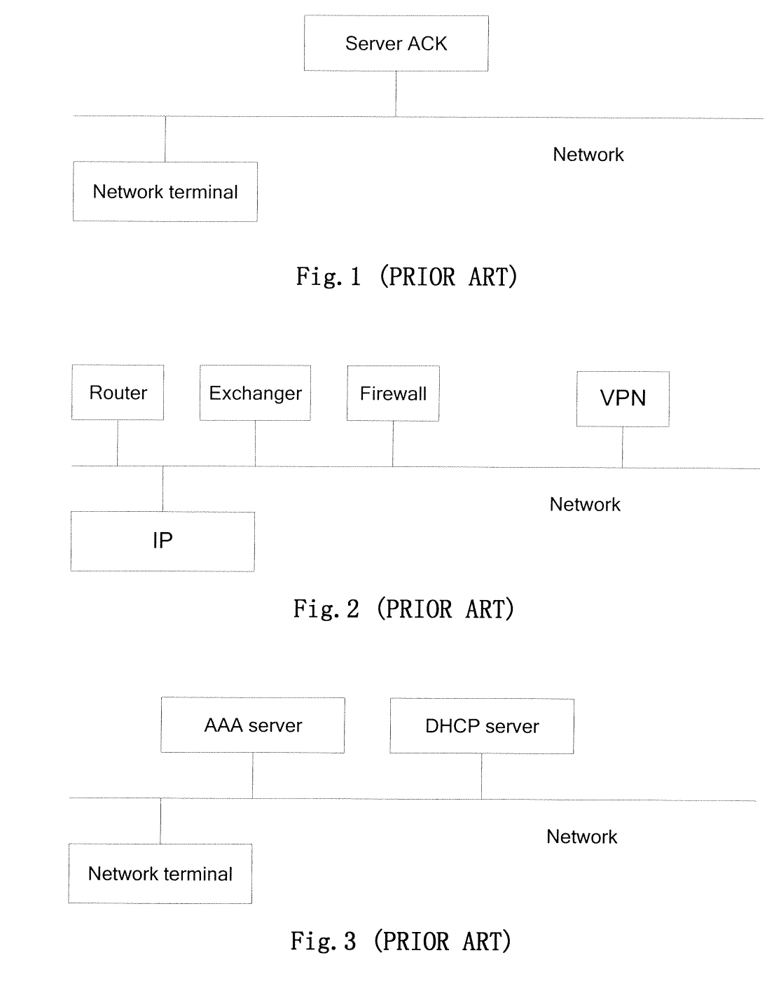

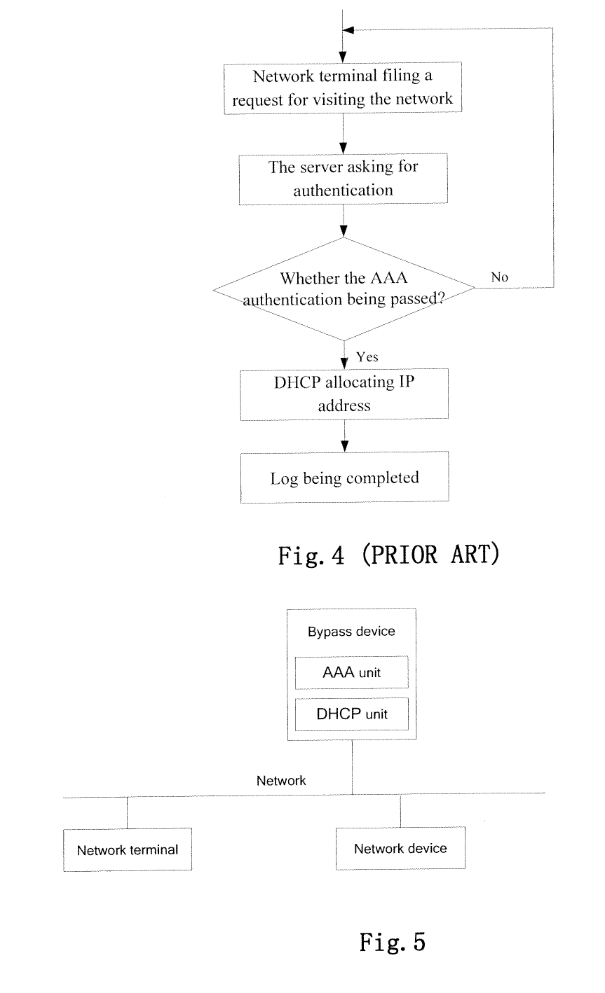

### DETAILED DESCRIPTION OF THE INVENTION

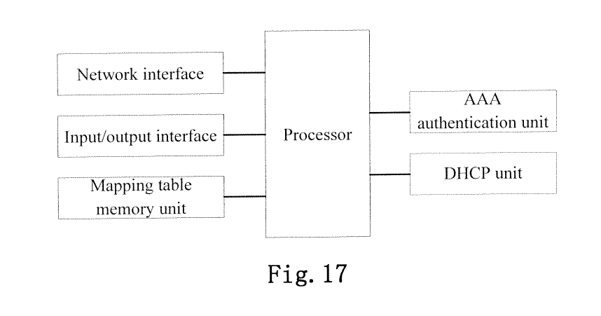

The embodiments of the present invention will be described with reference to the accompanied drawings. As shown in FIG. 17, a network-based IP allocation bypass device according to an embodiment of the present invention includes a processor, a network interface, an input/output interface, a memory, an AAA authentication unit and a DHCP unit.

The processor is connected respectively to the network interface, the input/output interface, the memory, the AAA authentication unit and the DHCP unit and controls the operation of the bypass device. The mapping relation between the parameters of a visitor and an IP address is stored in the memory; the network interface is used to receive a request for visiting the network filed employing the parameters of the visitor; the AAA authentication unit is used to perform authentication of AAA according to the received parameters of the visitor; the DHCP unit is used to find the IP address corresponding to the successful parameters of the visitor from the mapping relation between the parameters of the visitor and the IP address and allocate the found IP address via DHCP to the network terminal being used by the visitor.

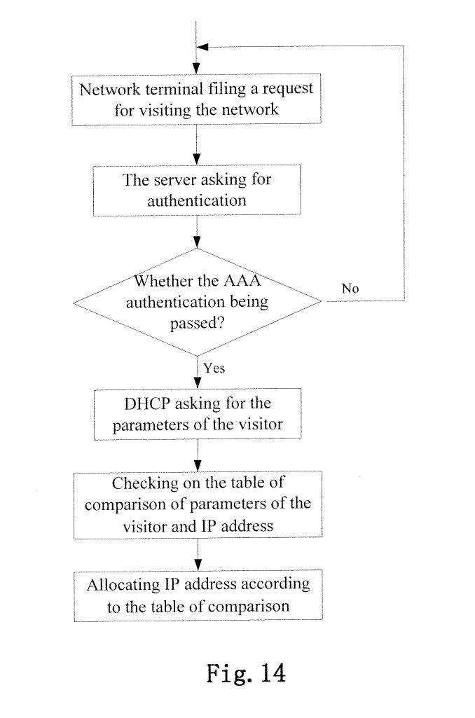

As shown in FIG. 5, the network terminal is connected to the IP allocation bypass device via the network, and when a visitor is to visit a network, the following steps (as shown in FIG. 14) are performed: 1) filing a request containing the parameters of the visitor at the terminal of the network for visiting the network; 2) the IP allocation bypass device requiring authentication; 3) after the AAA authentication is passed, the DHCP unit finding and obtaining the IP address or a set of IP addresses corresponding to the parameters of the present visitor from the stored mapping relation between the parameters of the visitor and the IP address and allocating the obtained IP address to the network terminal; 4) logging in to visit the network on the basis of the allocated IP address.

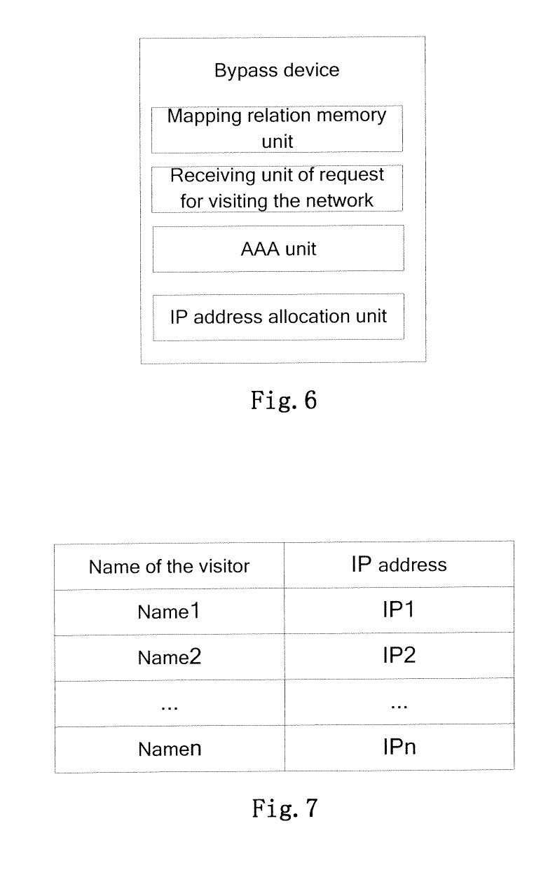

As shown in FIG. 6, the parts included in the bypass device are: a mapping relation memory unit for memorizing the mapping relation between the parameters of a visitor and an IP address; a receiving unit of request for visiting the network, for receiving the request for visiting the network filed employing the parameters of the visitor; an AAA authentication unit for performing authentication of AAA according to the received parameters of the visitor; an IP address allocation unit for finding the IP address corresponding to the successful parameters of the visitor from the mapping relation between the parameters of the visitor and the IP address and allocating the found IP address via DHCP to the network terminal being used by the visitor.

As shown in FIG. 7, the parameters of the visitor comprise names of the network visitors, each name mapping an IP address.

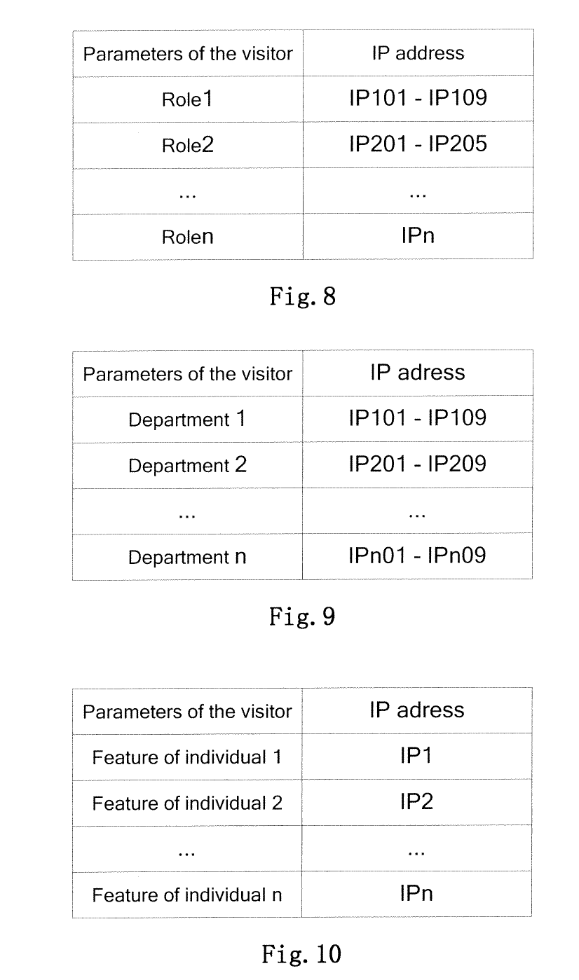

As shown in FIG. 8, the parameters of the visitor comprise roles of the network visitors, each role mapping one or more of the IP addresses. A role of the network visitor may be a general manager, a vice general manager, a department manager or a network visitor, etc.

As shown in FIG. 9, the parameters of the visitor comprise the departments of the network visitors, each department of the network visitors may be a department within a company, such as department of personnel, department of sales, department of production and department of administration, etc.

As shown in FIG. 10, the parameters of the visitor comprise the features of the network visitors, each feature of the network visitors may be the fingerprint, iris and period of age, etc., of the network visitor.

The parameters of the visitor shown in FIGS. 7-10 are one-dimension parameters, referring to the parameter of the visitor consisting of one piece of characteristic information. Such characteristic information comprises: name, general manager, vice general manager, department manager, the network visitor, department of personnel, department of sales, department of production, department of administration, fingerprint, iris and period of age, etc.

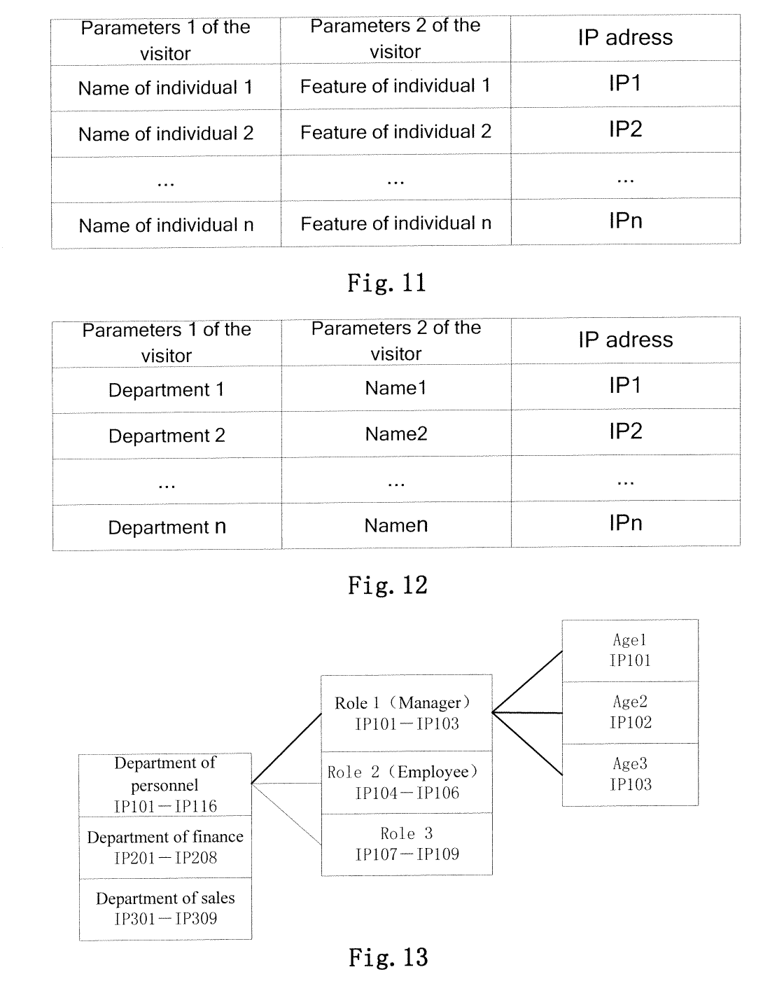

As shown in FIG. 11 and 12, the parameters of the visitor are two-dimension parameters consisting of two pieces of characteristic information; each of the two-dimension parameters mapping one or more of the IP addresses. Examples of two-dimension parameters are “fingerprint of the visitor” and “name”, or “department” and “name”, etc.

The parameters of the visitor may be also three-dimension or multi-dimension parameters. The three-dimension parameter refers to the parameter of the visitor consisting of three pieces of characteristic information, such as “name” plus “fingerprint” plus “department”, or “name” plus “visitor” plus “department”, etc.

### Embodiment 1

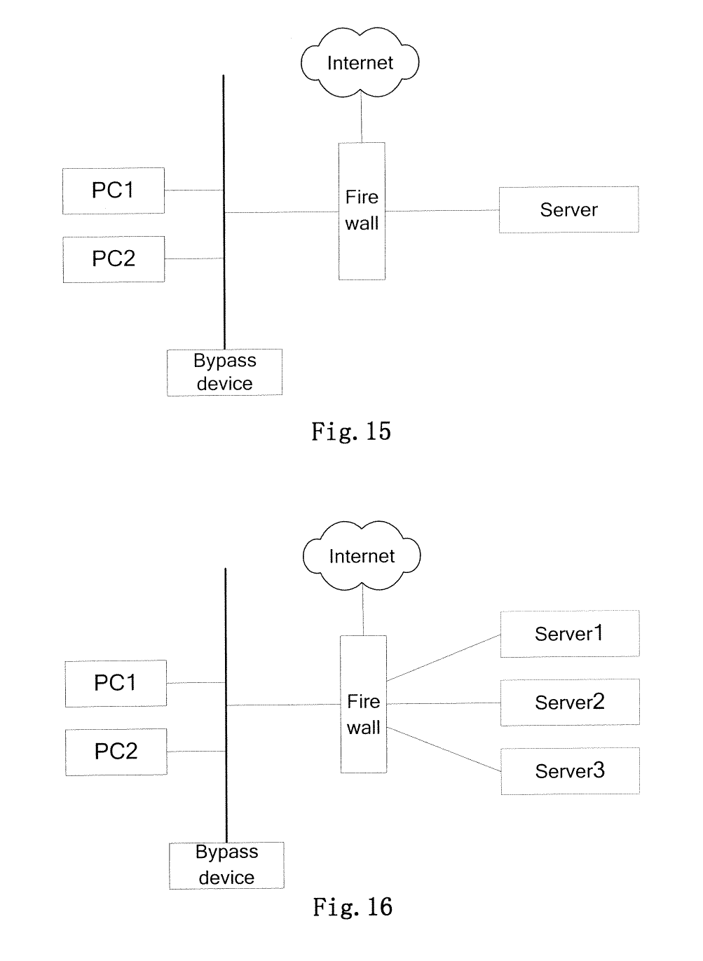

As shown in FIG. 15, the visitor makes access to the server through the firewall via the network terminals PC1 and PC2, and maps between the ID and IP through the bypass device according to an embodiment of the present invention. To facilitate the administration of the network, the accesses of all the visitors are differently defined: A is the manager of the department of personnel, who has the access to the internal server, as well as the access to Internet; B is a common visitor with the department of personnel, who has access to the internal server, but has no access to Internet; C is a common visitor with the department of finance, who has access to Internet, but has no access to the internal server. The user administration of A, B and C is shown in Table 3 below.

TABLE 3

| | | | Access to the internal | Access to |
|---|---|---|---|---|
| Name | Department | Position | server | Internet |
| A | Personnel | Manager | Yes | Yes |
| B | Personnel | Common | Yes | No |
| | | visitor | | |
| C | Finance | Common | No | Yes |
| | | visitor | | |

The network is managed based on ID in this embodiment. An ID administration module is provided in the bypass device, which includes the IDs and information on classification of A, B and C, for example, the group and identity of each of the visitors are defined according to the department and position of the visitor, and an ID is given to the visitor, as shown in Table 4 below.

TABLE 4

| ID | Name | Department | Position |
|---|---|---|---|
| Alex | A | Personnel | Manager |
| Unreal | B | Personnel | Common visitor |
| Dou | C | Finance | Common visitor |

A mapping relation memory module is provided in the bypass device, the memory module memorizes the IP address sections used respectively by the visitors; in this embodiment, IP address sections may be defined according to different positions, names, departments or combinations thereof, such as setting an IP address section according to the department, as shown in Table 5 below.

TABLE 5

| Department | IP address section |
|---|---|
| Personnel | 192.168.1.1-192.168.1.16 |
| Finance | 192.168.1.17-192.168.1.24 |

The IP address section may be also individually defined according to the department, position or ID of the visitor. For example, for the department of personnel, as employees with this department may call the data about the personnel with the company, the visitors with the department of personnel have more accesses than those of sections of personnel of other departments of the company. To ensure more accesses of the employees with the department of personnel, the IP addresses of the visitors with the department of personnel need to be differed from those of other common visitors with other departments, thus, an IP address section may be separately defined for the department of personnel, such as 192.168.1.1-192.168.1.16, which IP address section comprising 16 IP addresses, that means the parameters of the visitors with the department of personnel should be less than or equal to 16. Since a mapping relation is established between the department of personnel and the IP address section of 192.168.1.1-192.168.1.16, the IP address section is reserved and, when A or B with the department of personnel makes access to the network, one of the addresses of 192.168.1.1-192.168.1.16 shall be allocated.

In the ID administration module, the access may be defined according to the department, position, ID or the combination thereof, in this embodiment, the access is defined according to the department and position, as shown in Table 6 below.

TABLE 6

| | | | Access to the | Access to |
|---|---|---|---|---|
| Name | Department | Position | internal server | Internet |
| A | Personnel | Manager | Yes | Yes |
| B | Personnel | Common | Yes | No |
| | | visitor | | |
| C | Finance | Common | No | Yes |
| | | visitor | | |

When A uses a PC to access the network, a request for access shall be filed first by the PC to the AAA authentication unit:

The AAA authentication unit accepts the request and asks the PC for identity authentication;

The PC sends the authentication information Alex entered by A to an end of the AAA authentication unit;

The AAA authentication unit authenticates the identity of A according to the authentication information Alex and, if the authentication is successful, the DHCP unit shall allocate an IP address according to the ID of A following the tables 4 and 5, namely, if A is the manager of the department of personnel and the mapped IP address is 192.168.1.16, the IP address of 192.168.1.16 shall be allocated to the PC being used by A. The steps of access to the network for B and C are the same as those of A and shall not be described furthermore.

The bypass device may record the ID and IP allocated by the DHCP unit as well as the information on the time in a manner of log, as shown in Table 7 below.

TABLE 7

| ID | IP | Time of start | Time of termination |
|---|---|---|---|
| Alex | 192.168.1.8 | 16:30 7-20-2007 | 17:00 7-20-2007 |
| Unreal | 192.168.1.9 | 8:00 7-20-2007 | 17:00 7-20-2007 |
| Dou | 192.168.1.17 | 10:00 7-20-2007 | 12:00 7-20-2007 |

The access control unit of the firewall sets accesses of different IPs according to Tables 5 and 6, and combines them with Table 7 to establish an access control scheme.

### EXAMPLE 2

As shown in FIG. 16, the visitor makes access to the server 1, server 2 or server 3 through the firewall via the network terminals PC1 and PC2, and maps between the ID and IP through the bypass device according to an embodiment of the present invention. To facilitate the administration of the network, the accesses of all the visitors are differently defined: A is the manager of the department of personnel, who has the access to the server 1; B is a common visitor with the department of personnel, who has access to the server 2; C is a common visitor with the department of finance, who has access to server 3. The user administration of A, B and C is shown in Table 8 below.

TABLE 8

| | | | Access the | Access to | Access to |
|---|---|---|---|---|---|
| Name | Department | Position | server 1 | server 2 | server 3 |
| A | Personnel | Manager | Yes | No | No |
| B | Personnel | Common | No | Yes | No |
| | | visitor | | | |
| C | Finance | Common | No | No | Yes |
| | | visitor | | | |

The network is managed based on ID in this embodiment. An ID administration module is provided in the bypass device, which includes the IDs and information on classification of A, B and C, for example, the group and identity of each of the visitors are defined according to the department and position of the visitor, and an ID is given to the visitor, as shown in Table 4.

A mapping relation memory module is provided in the bypass device, the memory module memorizes the IP address sections used respectively by the visitors; in this embodiment, IP address sections may be defined according to different positions, names, departments or combinations thereof, such as setting an IP address section according to the department, as shown in Table 5.

The IP address section may be also defined individually according to the position of ID of the visitor. For example, as A is the manager of the department of personnel, he has more accesses than other common visitors in the department of personnel. To ensure more accesses of A, the IP addresses of the manager need to be differed from those of other common visitors with the department, thus, an IP address section may be seperately defined for the manager of the department of personnel, such as 192.168.1.16.

In the ID administration module, the access may be defined according to the department, position, ID or the combination thereof, in this embodiment, the access may is defined according to the department and position, as shown in Table 9 below.

TABLE 9

| Department | Position | Server 1 | Server 2 | Server 3 |
|---|---|---|---|---|
| Personnel | Manager | Yes | No | No |
| Personnel | Common visitor | No | Yes | No |
| Finance | Common visitor | No | No | Yes |

When C uses a PC to access the network, a request for access shall be filed first by the PC to the AAA authentication unit:

The AAA authentication unit accepts the request and asks the PC for identity authentication;

The PC sends the authentication information Alex entered by C to an end of the AAA authentication unit;

The AAA authentication unit authenticates the identity of C according to the authentication information Dou and, if the authentication is successful, the DHCP unit shall allocate an IP address according to the ID of C (Dou) following the tables 4 and 5, namely, if C is a common visitor with the department of finance and the mapped IP address is 192.168.1.17, the IP address of 192.168.1.17 shall be allocated to the PC being used by C. The steps of access to the network for B and A are the same as those of C and shall not be described furthermore.

The bypass device may record the ID and IP allocated by the DHCP unit as well as the information on the time in a manner of log, as shown in Table 7. The access control unit of the firewall sets accesses of different IPs according to tables 5 and 9 and combines them with Table 7 to establish an access control scheme.

### EXAMPLE 3

As shown in FIGS. 13 and 16, the visitor makes access to the server 1, server 2 or server 3 through the firewall via the network terminals PC1 and PC2, and maps between ID and IP through the bypass device according to an embodiment of the present invention. To facilitate the administration of the network, the accesses of all the visitors are differently defined: A, aged 55, is the first manager of the department of personnel, who has the access to the server 1; B, aged 40, is the second manager of the department of personnel 1, who has access to the server 2; C, aged 30, is the third manager of the department of personnel, who has access to server 3. The user administration of A, B and C is shown in Table 10 below.

TABLE 10

| Name | Department | Position | Age | Server 1 | Server 2 | Server 3 |
|---|---|---|---|---|---|---|
| A | Personnel | Manager | 55 | Yes | No | No |
| B | Personnel | Manager | 40 | No | Yes | No |
| C | Personnel | Manager | 30 | No | No | Yes |

As shown in FIGS. 13, when B uses a PC to access the network, a request for access shall be filed first by the PC to the AAA authentication unit:

The AAA authentication unit accepts the request and ask the PC for identity authentication;

The PC sends the authentication information “Unreal” entered by B to an end of the AAA authentication unit;

The AAA authentication unit authenticates the identity of B according to the authentication information “Unreal” and, if the authentication is successful, the DHCP unit shall allocate an IP address according to the ID of B (Unreal) following the tables 10 and 13, namely, if B is the second manager with the department of personnel and the mapped IP address is IP102, the IP address of IP102 shall be allocated to the PC being used by B. The steps of access to the network for C and A are the same as those of B and shall not be described furthermore.

A method and bypass based on the network have been disclosed. Although the present methods and bypass have been described with respect to specific examples, it will be apparent to those of ordinary skill in the art that it is not limited to these specific examples but extends to other embodiments as well.

What is claimed is:

1. A method of IP allocation based on a network comprising:
establishing a mapping relation between the parameters of a visitor and an IP address;
filing a request for visiting the network using the parameters of the visitor;
performing authentication of AAA according to the parameters of the visitor; and
finding the IP address corresponding to the successful parameters of the visitor from the mapping relation between the parameters of the visitor and the IP address, and allocating the found IP address via DHCP to the network terminal being used by the visitor, to achieve the allocation of IP address based on the parameters of the visitor.

2. The method of claim 1, wherein the IP address is a single IP address or an IP address section consisting of multiple IP addresses.

3. The method of claim 1, wherein the parameters of the visitor are characteristic information including at least one of the name, a role, or a department and feature of the visitor representing the characteristics of the visitor.

4. The method of claim 3, wherein the parameters of the visitor include one-dimension, two-dimension and three-dimension parameters, the method further comprising:
the one-dimension parameter refers to the parameter of the visitor consisting of one piece of characteristic information;
the two-dimension parameters refer to the parameters of the visitor consisting of two pieces of characteristic information; and
the three-dimension parameters refer to the parameters of the visitor consisting of three pieces of characteristic information.

5. The method of claim 4, wherein establishing a mapping relation between the parameters of a visitor and an IP address comprises:
establishing a mapping relation between the one-dimension parameter and a single IP address or multiple IP addresses;
establishing a mapping relation between the two-dimension parameters and a single IP address or multiple IP addresses; and
establishing a mapping relation between the three-dimension parameters and a single IP address or multiple IP addresses.

6. The method of claim 5, wherein establishing a mapping relation between the one-dimension parameter and a single IP address or multiple IP addresses refers to mapping the one-dimension parameter with an IP address section consisting of multiple IP addresses; and
in the mapping relation between the parameters of the visitor and the IP address, finding the IP address section corresponding to the one-dimension parameter successfully authenticated by the AAA, and allocating one IP address of the found IP address section to the network terminal being used by the visitor through the DHCP, to achieve the IP address section allocation based on the parameters of the visitor.

7. The method of claim 6, wherein the number of IP addresses included in the IP address section is greater than that of the one-dimension parameters corresponding to the IP address section.

8. The method of claim 1, wherein the method is used in the net work device comprising a router, a firewall, an exchanger, and a VPN.

9. The method of claim 3, wherein the method is used in the net work device comprising a router, a firewall, an exchanger, and a VPN.

10. The method of claim 7, wherein the method is used in the net work device comprising a router, a firewall, an exchanger, and a VPN.

11. A bypass device of IP allocation based on a network comprising:
a mapping relation memory unit for memorizing the mapping relation between the parameters of a visitor and an IP address;
a receiving unit of request for visiting the network, for receiving the request for visiting the network filed employing the parameters of the visitor;
an AAA authentication unit for performing authentication of AAA according to the received parameters of the visitor; and
an IP address allocation unit for finding the IP address corresponding to the successful parameters of the visitor from the mapping relation between the parameters of the visitor and the IP address and allocating the found IP address via DHCP to the network terminal being used by the visitor.

12. The device of claim 11, wherein the IP address is a single IP address or an IP address section consisting of multiple IP addresses.

13. The device of claim 11, wherein the parameters of the visitor are characteristic information including at least one of the name, a role, or a department and feature of the visitor representing the characteristics of the visitor.

14. The device of claim 13, wherein the parameters of the visitor include one-dimension, two-dimension and three-dimension parameters, the device further comprising:
the one-dimension parameter refers to the parameter of the visitor consisting of one piece of characteristic information;
the two-dimension parameters refer to the parameters of the visitor consisting of two pieces of characteristic information; and
the three-dimension parameters refer to the parameters of the visitor consisting of three pieces of characteristic information.

15. The device of claim 14, wherein establishing a mapping relation between the parameters of a visitor and an IP address comprises:
establishing a mapping relation between the one-dimension parameter and a single IP address or multiple IP addresses;
establishing a mapping relation between the two-dimension parameters and a single IP address or multiple IP addresses; and
establishing a mapping relation between the three-dimension parameters and a single IP address or multiple IP addresses.

16. The device of claim 14, wherein establishing a mapping relation between the one-dimension parameter and a single IP address or multiple IP addresses refers to mapping the one-dimension parameter with an IP address section consisting of multiple IP addresses; and
in the mapping relation between the parameters of the visitor and the IP address, finding the IP address section corresponding to the one-dimension parameter successfully authenticated by the AAA, and allocating one IP address of the found IP address section to the network terminal being used by the visitor through the DHCP, to achieve the IP address section allocation based on the parameters of the visitor.

17. The device of claim 16, wherein the number of IP addresses included in the IP address section is greater than that of the one-dimension parameters corresponding to the IP address section.

18. The device of claim 1, wherein the device is built in the network device comprising a router, a firewall, an exchanger and a VPN, or is used separately.

19. The device of claim 13, wherein the device is built in the network device comprising a router, a firewall, an exchanger and a VPN, or is used separately.

20. The device of claim 16, wherein the device is built in the network device comprising a router, a firewall, an exchanger and a VPN, or is used separately.
